(19) United States
(12) Patent Application Publication
(10) Pub. No.: US 2026/0117076 A1
(43) Pub. Date: Apr. 30, 2026

(54) FOULING CONTROL COATING COMPOSITION

(71) Applicant: Akzo Nobel Coatings International B.V., Amsterdam (NL)

(72) Inventor: James Ferguson, Amsterdam (NL)

(21) Appl. No.: 19/477,856

(22) PCT Filed: May 1, 2024
(86) PCT No.: PCT/EP2024/062004

§ 371 Date: Oct. 23, 2025

(30) Foreign Application Priority Data
May 4, 2023 (EP) 23171704.2

(51) Int. Cl. C09D 5/16; C08F 290/06; C09D 151/08

(52) U.S. Cl. CPC C09D 5/1675; C08F 290/068; C09D 151/085

(57) ABSTRACT

The disclosure is directed to a fouling control coating composition comprising an anionic polymer with one or more metallic cations, in which the anionic polymer has a siloxane moiety that is covalently bound via an amide group. The anionic polymer is an acrylate-based co-polymer made from at least one acrylate-based monomer and at least one acrylamide-based monomer having an attached polysiloxane moiety. The composition is particularly useful as a self-polishing fouling control coating.

### CROSS REFERENCE TO RELATED APPLICATION

This application is a 35 U.S.C. § 371 national phase application of PCT Application No. PCT/EP2024/062004 (published as WO/2024/227830), filed May 1, 2024, which claims the benefit of priority to EP Application Serial No. 23171704.2, filed May 4, 2023, each of which is incorporated herein by reference in their entirety.

### TECHNICAL FIELD

This disclosure relates to a fouling control coating composition, to a substrate or article coated with such a fouling control coating composition, and to a method for controlling aquatic biofouling on man-made objects using such a coating.

### BACKGROUND ART

Fouling of ship hulls and other water-borne objects by aquatic organisms is a continuing problem. Fouling can increase frictional resistance of boats in the water, increasing fuel costs. On static structures, for example on drilling rigs, it can alter the water flow around the supporting legs, risking unpredictable and increased stresses. Fouling can also make inspections more difficult by obscuring defects and cracks. It can further reduce the cross-sectional area of pipework such as cooling water or ballast tank intakes, leading to reduced flow rates.

Coatings can be used to reduce fouling. Such coatings can contain a biocide to control the growth of aquatic organisms on the surface. These fall typically into two broad categories, namely “hard” antifouling coatings, where biocide gradually leaches from the coating over time, and “eroding” antifouling coatings (sometimes called self-polishing coatings), where the coating gradually erodes to release the biocide. However, biocides can carry environmental risks, particularly in areas with heavy shipping activity. They are therefore the subject of increasingly stringent environmental legislation.

Biocide-free coatings are available, which include so-called “fouling release” coatings, which have a “low surface energy” surface that inhibits adherence of fouling organisms, and also causes them to be more easily washed from the surface. The fouling control effects can be enhanced by including non-biocidal adhesion reducing fluids in the formulation. Biocide-free self-polishing coatings can also be used, so-called surface active self-polishing coatings, where the gradual wear or dissolution continually presents a new, clean surface that is designed to prevent biofouling settlement and growth, and which promotes its release. Examples are described in WO2004/081121 and WO2009/011332.

Self-polishing coatings are another type of fouling control coating. These gradually wear or dissolve during to continuously present a new, clean surface, and their activity can be enhanced by including biocidal antifouling agents. Examples are described in EP2489710, EP2489711, JP2006077095, US2017/0022373, WO2004/081121, WO2009/011332 and WO2019/081495.

However, there remains a need for further types of fouling control coatings with improved properties.

### SUMMARY

The present disclosure is a fouling control coating composition comprising an anionic polymer with one or more metallic cations, in which the anionic polymer has a siloxane moiety that is covalently bound via an amide group. The anionic polymer is an acrylate-based co-polymer made from at least one acrylate-based monomer and at least one acrylamide-based monomer having an attached polysiloxane moiety.

The present disclosure is also directed to a method for controlling aquatic biofouling on a man-made object, comprising applying the above coating composition onto the surface of a man-made structure. The man-made structure is one that is intended to be permanently or intermittently immersed in water, e.g. sea water, fresh water or brackish water.

The disclosure is further directed to a substrate or article coated with the above-mentioned fouling control coating composition, both before and after drying and/or curing.

The disclosure is additionally directed to the use of such a coating composition for controlling aquatic biofouling of a man-made structure.

### Terminology

In the discussion below, reference to quantities of components in the coating composition as a whole are to the uncured or undried composition, unless otherwise stated. Also, unless otherwise stated, concentrations given are in wt % of the coating composition as a whole. Where a coating composition is provided in separate parts (e.g. a binder-containing part and a curing agent-containing part) the amount of a component in the coating composition as a whole is based on the total amount of components in all the different parts combined.

References to “terminal” groups in a resin, polymer or oligomer are to groups bound to the oligomer/polymer chain or “backbone” at the end (terminal) positions. References to “pendant” groups are to groups attached to the oligomer/polymer chain at positions other than terminal positions.

References to “aliphatic hydrocarbyl” groups or substituents include saturated and unsaturated hydrocarbyl groups (e.g. alkyl or alkenyl groups), which can be cyclic, linear or branched, or comprise a mixture of cyclic and non-cyclic portions. Similarly, references to “alkyl” or “alkenyl” groups or substituents includes cyclic, linear or branched groups, or groups comprising a mixture of cyclic and non-cyclic portions. Unsaturated groups, for example alkenyl groups, have a minimum of two carbon atoms.

References to “aryl” are to aromatic hydrocarbon groups that can comprise one or more aromatic rings. References to “heteroaryl” are to aromatic groups that comprise one or more heteroatoms in the aromatic ring, typically selected from oxygen, nitrogen and sulfur.

The monomer (or monomer unit) content of a polymer or oligomer, expressed in either weight % or molar %, can be calculated from, respectively, the weight fraction or the mole fraction of monomer used to make the polymer or oligomer.

The term “monomer unit” refers to a constituent monomer of a polymer, i.e. to the moiety derived from the monomer after being incorporated into a polymer.

Atmospheric pressure is defined as 1.013 bar-a, where bar-a represents bar-absolute as opposed to bar-gauge.

The term “saturated carbon atom” refers to a carbon atom that has four single covalent bonds to other atoms, and no double or triple covalent bonds to other atoms.

The abbreviation PDMS refers to polydimethylsiloxane.

### DETAILED DESCRIPTION

### [Anionic Polymer]

The coating composition comprises one or more binder resins, at least one of which is an acrylate-based anionic polymer comprising one or more metallic cations. The anionic polymer can be formed from at least one monomer with an anionic functionality, in which one or more metallic cations are used to balance the negative charge. In embodiments, the anionic polymer is a thermoplastic polymer.

Examples of anionic polymers include those having an anionic moiety selected from phosphonate, sulfonate, carboxylate and carbonate. At least one anionic moiety, is carboxylate, and in further embodiments all anionic moieties are carboxylate.

The anionic polymer comprises a siloxane moiety covalently bound via an amide link. The anionic polymer can be formed by polymerisation of unsaturated monomers, at least one of which has the amide-attached siloxane moiety. In an alternative embodiment, the siloxane moiety can be attached to the polymer, e.g. by forming the polymer from a monomer having a suitable functional group to which the siloxane moiety can be attached.

The monomer to which at least one siloxane (or all siloxanes) is attached is an acrylamide-based monomer, which will be discussed in more detail below. The siloxane moiety is also discussed below. Before attachment to the acrylamide-based monomer, it can comprise a group that is reactive with the amide moiety of the monomer, typically positioned at a terminal end of the siloxane group. In embodiments, the siloxane moiety before attachment to the monomer or polymer comprises just one group that is reactive with the amide. The siloxane moiety can comprise other functional groups at pendant or terminal positions that are unreactive with an amide moiety, although in embodiments there are no other reactive groups.

The amounts of metallic cation-containing anionic polymer in the coating composition can be in the range of from 20 to 80 wt %, for example 20 to 75 wt %, from 25 to 70 wt % or from 25 to 60 wt %.

### [Metallic Cations]

The metallic cations can be selected from divalent or trivalent metal ions. In embodiments, they can be selected from alkaline earth metal ions (e.g. Mg, Ca, Sr), transition metal or “d-block” ions (e.g. first row transition metals such as Ti, Fe, Co, Ni, Cu, Zn), main-group “p-block” metals (e.g. Al, Sn), and lanthanides (e.g. La, Ce, Pr). They can be selected from Mg, Ca, Zn and Cu, and are typically selected from Cu and Zn.

The metallic cations can be provided in the form of a salt of an anionic monomer, e.g. as a metal salt of an acrylate-based monomer as described in more detail below. In other embodiments, it can be provided in the form of a separate salt, e.g. as a salt of an organic acid such as a carboxylic acid, examples of which are also provided in more detail below.

The metal content of the metallic ion-containing anionic polymer can be in the range of from 1 to 20 wt %, for example from 2 to 15 wt % or from 2 to 10 wt %.

### [Siloxane Moiety]

The anionic polymer comprises a siloxane moiety that is covalently bound via an amide link. The siloxane moiety can be linear, branched or cyclic, or can comprise a mixture of cyclic and non-cyclic portions or regions. In embodiments, the siloxane moiety comprises from 4 to 150 silicon atoms. In embodiments, the siloxane moiety and amide link to the polymer can be represented by Formula (1):

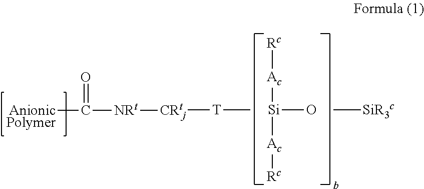

b is in the range of from 3 to 150, for example in the range of from 3 to 100 or from 8 to 80. c is in the range of from 0 to 20, for example from 0 to 10, from 0 to 5 or from 0 to 3. j is in the range of from 1 to 6, for example from 2 to 4.

Each A is [OSi(R^{c})₂].

Each R^{c} is independently selected from optionally substituted C₁₋₂₀ aliphatic hydrocarbyl groups, optionally substituted C₆₋₁₂ aryl groups, and optionally substituted C₆₋₁₂ aryl groups having one or more C₁₋₆ alkyl groups. Optional substituents are defined further below.

T is —O—, —NR^{t}— or is absent.

Each R^{h} is independently selected from H and C₁₋₂₀ alkyl, optionally substituted as set out further below. In embodiments, the C₁₋₂₀ alkyl is C₁₋₁₀ or C₁₋₆ alkyl.

Each R^{t} is independently selected from H, C₁₋₆ alkyl and C₁₋₆ haloalkyl, where halo can be selected from Cl and Br.

In embodiments, the siloxane moiety and its amide linkage to the anionic polymer can be represented by Formula (2):

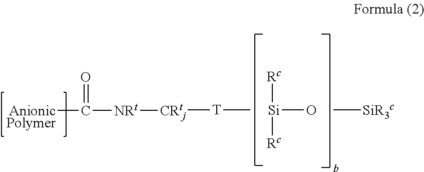

In embodiments, in any of Formulae (1) and (2), there are no halides or halide-containing substituents.

In embodiments, in Formula (2), each Re is an unsubstituted C₁₋₆ alkyl group or a phenyl group optionally substituted with one or more C₁₋₆ alkyl groups. In embodiments, each R^{c} is unsubstituted methyl or unsubstituted phenyl.

### [Monomer Units of the Anionic Polymer]

The anionic polymer is an acrylate-based co-polymer. Such polymers or copolymers are obtainable by polymerisation of a mixture of monomers comprising one or more acrylate-based and/or acrylamide-based monomers. An acrylate-based monomer is a monomer having an acrylate moiety, in which a C═C double bond is directly bonded to a carboxyl or carboxylate group. An acrylamide-based monomer is one where the C═C double bond is bound directly to an amide group.

In embodiments, the acrylate-based polymer comprises one or more acrylate-based monomer units represented by Formula (3):

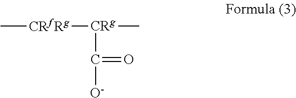

Each R^{f} is selected from H, C₁₋₂₀ aliphatic hydrocarbyl, C₆₋₁₂ aryl, and C₆₋₁₂ aryl with one or more substituents selected from C₁₋₆ alkyl, C(O)O⁻ and C(O)OR^{t};

Each R^{g} is independently selected from H and C₁₋₂₀ aliphatic hydrocarbyl (e.g. alkyl), C₆₋₁₂ aryl and C₆₋₁₂ aryl substituted with one or more (e.g. 1 to 4) C₁₋₆ aliphatic hydrocarbyl groups. Each aliphatic hydrocarbyl substituent, aliphatic hydrocarbyl group and aryl group in R^{f} and R^{g} can also optionally be substituted as described further below.

In embodiments, the C₁₋₂₀ aliphatic hydrocarbyl can be selected from C₁₋₁₀ or C₁₋₆ aliphatic hydrocarbyl groups, such as C₁₋₁₀ or C₁₋₆ alkyl groups. In embodiments, each R^{g} is selected from hydrogen and methyl.

In embodiments, the R^{g} groups are selected independently from H and unsubstituted C₁₋₆ alkyl, for example H and C₁₋₄ alkyl, such as H and methyl. In embodiments, R^{f} is selected from H, —C(O)O⁻, —C(O)OR^{t}, and C₁₋₆ alkyl optionally substituted with one or more groups selected from —C(O)O⁻ and —C(O)OR^{t}. In embodiments, where R^{f} is an optionally substituted C₁₋₆ alkyl group, there is only one optional —C(O)O⁻ or —C(O)OR^{t} substituent.

In embodiments, the acrylate-based polymer is a co-polymer comprising one or more additional monomer units. In various embodiments, one or more additional monomer units can be selected from those represented by Formula (4):

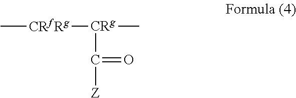

R^{f} and R^{g} are as defined above. Z is selected from —OR^{h}, and —N(R^{h})₂.

In embodiments, where Z is N(R^{h})₂, none of R^{f} and R^{g} contain any carbonyl-containing moieties, i.e. —C(O)O⁻, —C(O)OR^{t} or —C(O)NR^{t}₂.

Each R^{h} is independently selected from H and C₁₋₂₀ alkyl, optionally substituted as set out further below. In embodiments, the C₁₋₂₀ alkyl is C₁₋₁₀ or C₁₋₆ alkyl.

In embodiments, the monomer(s) of Formula (3) can be based on acrylate, methacrylate, itaconate, maleate, or crotonate. These also apply for monomer(s) of Formula (4), but they can also include acrylamide and methacrylamide. In embodiments, monomers of Formula (3) and (4) are based on acrylate or methacrylate.

In embodiments, there is at least one monomer unit of Formula (4) where Z is N(R^{h})₂, where a siloxane moiety is a substituent on an R^{h} group, and where the siloxane moiety can be:

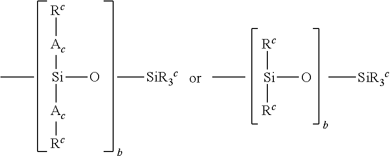

Typically, the siloxane moiety is a substituent on one R^{t} group of an —NR^{t}₂ moiety, for example being represented as:

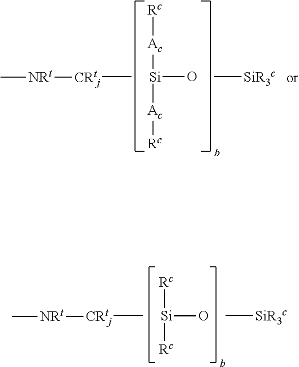

In such embodiments, NR^{t} is NH, and CR^{t}ⱼ is (CH₂)ⱼ where j is from 1 to 6, for example from 2 to 4.

In embodiments, the siloxane moiety can be attached to a monomer (pre- or -post polymerisation, typically pre-polymerisation) via a condensation reaction by reacting a siloxane with a terminal amine moiety with an acyl halide functional monomer, e.g. according to the following equation:

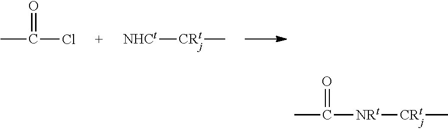

Other types of co-monomer (i.e. non acrylate- or acrylamide-based monomers) that can form part of the anionic polymer include those having polymerizable unsaturated carbon-carbon bonds, for example those represented by Formula (5):

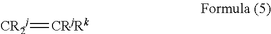

Each R^{j} is independently selected from H, halide (e.g. selected from F and Cl), and C₁₋₆ alkyl. R^{k} can be selected from R^{j}, C₂₋₆ alkenyl, C₆₋₁₂ aryl and C₆₋₁₂ aryl substituted with one or more C₁₋₆ aliphatic hydrocarbyl groups. In embodiments, only one of R^{j} and R^{k} can be a halide or comprise a halide-containing substituent. In embodiments R^{k} comprises C₆₋₁₂ aryl. In embodiments, the co-monomer can comprise one or more optional substituents, as set out above for those associated with R^{h} and R^{g}.

The average number of monomer units in the acrylate-based anionic polymer can be in the range of from 5 to 500, for example from 10 to 300.

In embodiments, an optionally substituted group can comprise from 1 to 4 substituents, for example 1 or 2 substituents.

In embodiments, the viscosity of the siloxane-modified anionic polymer is in the range of from 3 to 100 Poise, for example from 5 to 50 Poise, when measured at 25° C.

In embodiments, the metallic cation-containing siloxane-modified anionic polymer is made using anionic monomers in their acidic, i.e protonated form, e.g. where the monomer units are of Formula (4) where Z is OH, and subsequently exchanging the H ions with one or more metallic cations.

When making the siloxane-modified anionic polymer, the proportion of the anionic monomers (or protonated forms of the anionic monomers) in the mixture of monomers is typically in the range of from 0.5 to 20 wt %, for example from 1 to 12 wt %, such as from 2 to 10 wt %.

In embodiments, on a molar basis, the anionic monomer is an acrylate-based anionic monomer comprising at least 80% on a molar basis of monomer units according to Formulae (3) and (4). In further embodiments this amount is at least 90% or at least 95% on a molar basis. In still further embodiments, all monomer units are according to Formula (3) and (4).

In embodiments, in the anionic polymer, the amount of metal cations to anionic monomer units in the polymer is at least 80 mol %, for example at least 90 mol % or at least 95 mol %. In this sense, a monomer unit containing acidic groups, e.g. monomer units of Formula (4) where Z is-OH, is considered to be an anionic monomer unit. Otherwise, the anionic polymer can become too soluble, and degrade too quickly when in contact with water.

In embodiments, anionic monomer units that are not charge-balanced by metallic cations can be charge-balanced by other cations, such as protons or amine cations. In embodiments, substantially all anionic monomer units are charge balanced by metallic cations.

### [Optional Substituents]

Optional substituents on Re can be selected from halide (e.g. selected from F and Cl), —OR^{t} and —N(R^{t})₂.

Optional substituents for R^{g} and R^{h} can be selected from halide, —OR^{t}, —N(R^{t})₂, siloxane moieties as defined above, —OC(O)R^{t}, —C(O)N(R^{t})₂, and —OC(O)N(R^{t})₂. Additional optional substituents include polyether, polyamine and polyether/amine groups selected from —([CR^{t}₂]ⱼE-)ₚR^{t} and -E-([CR^{t}₂]ⱼE-)ₚR^{t}. Each E is independently selected from O and NR^{t}. Each R^{t} is as defined above. j can be from 1 to 6, such as from 2 to 4, and p can be from 1 to 20. For R^{f}, the same optional substituents apply, with further optional substituents being selected from —C(O)O—, —C(O)OR^{t}.

Any halide substituents or any halides in any of the substituents are typically selected from F and Cl.

### [Other Organic Anions]

The coating composition can comprise one or more further organic anions. They can be ionically bound to the polymer, for example as counter ions where the anionic polymer has a divalent or trivalent metal ion.

In embodiments, the organic anions are carboxylate anions having at least one carboxylate group. The organic anion typically comprises from 2 to 50 carbon atoms in total.

The organic ion can be a C₂₋₅₀ hydrocarbyl group with at least one carboxyl group and optionally one or more further substituents selected from halide (typically selected from F and Cl), OR^{t} and N(R^{t})₂ where R^{t} is as defined above. In embodiments, it is unsubstituted except for having at least one carboxyl group, for example 1 or two carboxyl groups. In embodiments, there is only one carboxyl group.

The hydrocarbyl group can be a C₄ to C₂₀ hydrocarbyl group selected from aliphatic, aromatic, or aliphatic-substituted aromatic groups.

In embodiments the organic ion is selected from carboxyl-containing compounds with an aliphatic group, e.g. a saturated aliphatic group, for example selected from C₄ to C₂₀ alkyl groups or C₆ to C₂₀ alkyl groups, including fatty acids, including fatty acids, naphthenic acids and versatic acids.

The organic ion can be part of a carboxyl-containing compound present in a rosin, for example a rosin selected from gum rosin, wood rosin and tall oil rosin. In embodiments the rosin can be a hydrogenated or disproportionated rosin.

### [Additional Components]

The coating composition may optionally also contain other components, for example one or more substances selected from curable resins, crosslinking agents, reactive diluents, anti-corrosion additives, pigments, gloss additives, waxes, rosins, fillers and extenders, thixotropic agents, plasticizers, inorganic and organic dehydrators (stabilizers), UV stabilizers, defoamers, and any combination thereof. These components are well-known to the skilled person.

The total amount of such further optional components can be in the range of from 0 to 65 wt % based on the total content of the coating composition, typically no more than 50 wt %, for example no more than 35 wt % of the coating composition.

Except for organic solvents, marine biocides, pigments, fillers and extenders, which are discussed further below, the coating composition comprises less than 5 wt % or less than 3 wt % in total of further optional components.

The coating compositions can have low amounts of non-volatile and non-reactive oligomeric or polymeric fluids (e.g. polysiloxane oils or fluoropolymers such as perfluoropolyethers), or hydrocarbon wax or oil mixtures (e.g. petrolatum), or even no such non-volatile and non-reactive fluids. For example, their content can be 5 wt % or less, such as 3 wt % or less, 1 wt % or less or 0.1 wt % or less.

### [Organic Solvents]

The composition can comprise one or more organic solvents. These are typically organic liquids that have a boiling point of 250° C. or lower at atmospheric pressure (i.e. 101.3 kPa or 1.013 bar-a), and evaporate from the coating composition during the drying and curing process.

They can be selected from hydrocarbon compounds and heteroatom-containing organic compounds, where heteroatoms are selected from O, S and N, for example O.

Examples of organic solvents include alkyl aromatic hydrocarbons (such as xylene, toluene and trimethyl benzene), aliphatic hydrocarbons (such as cyclic and acyclic hydrocarbons selected from C₄₋₂₀ alkanes, or mixtures of any two or more thereof), alcohols (such as benzyl alcohol, octyl phenol, resorcinol, n-butanol, isobutanol and isopropanol), ethers (such as methoxypropanol), glycol ethers (e.g. phenyl, benzyl or C₁₋₄ alkyl ethers or diethers of ethylene glycol, diethylene glycol, propylene glycol or dipropylene glycol), ketones (such as methyl ethyl ketone, methyl isobutyl ketone and methyl isopentyl ketone), and esters (such as butyl acetate). In embodiments, the organic solvent comprises from 2 to 20 carbon atoms, for example from 3 to 15 carbon atoms. Mixtures of any two or more organic solvents can be used.

The total amount of organic solvent can constitute up to 80 wt % of the total weight of the coating composition, for example in the range of from 10 to 80 wt %, from 20 to 80 wt % or from 25 to 65 wt %.

The organic solvent content is separate to the water content. The coating composition is typically a non-aqueous composition. Although water can be present, it is typically at a low concentration. If present, it is typically at concentrations of 5 wt % or less, for example 1 wt % or less.

### [Marine Biocides]

The coating composition can, in embodiments, comprise one or more marine biocides. These are chemical substances known to have chemical or biological biocidal activity against marine or freshwater organisms.

Although the coating compositions described herein do not require any additional marine biocides, they can be incorporated if desired. In embodiments, where marine biocide is present, it can be included at concentrations of up to 50 wt %, for example up to 30 wt % or up to 10 wt %. However, in embodiments, there are limited quantities of marine biocide, for example 1 wt % or less, such as 0.5 wt % or less, or 0.1 wt % or less based on the entire coating composition. In embodiments, the coating composition is free of marine biocide.

If used, examples of suitable marine biocides are well-known in the art and include inorganic, organometallic, metal-organic or organic biocides.

Examples of inorganic biocides include copper compounds such as copper oxide, copper thiocyanate, copper bronze, copper carbonate, copper chloride, copper nickel alloys, and silver salts such as silver chloride or nitrate.

Organometallic and metal-organic biocides include zinc pyrithione (the zinc salt of 2-pyridinethiol-1-oxide), copper pyrithione, bis(N-cyclohexyl-diazenium dioxy) copper, zinc ethylene-bis(dithiocarbamate) (i.e. zineb), zinc dimethyl dithiocarbamate (ziram), and manganese ethylene-bis(dithiocarbamate) complexed with zinc salt (i.e. mancozeb).

Organic biocides include formaldehyde, dodecylguanidine monohydrochloride, thiabendazole, medetomidine, N-trihalomethyl thiophthalimides, trihalomethyl thiosulphamides, N-aryl maleimides such as N-(2,4,6-trichlorophenyl) maleimide, 3-(3,4-dichlorophenyl)-1,1-dimethylurea (diuron), 2,3,5,6-tetrachloro-4-(methylsulphonyl) pyridine, 2-methylthio-4-butylamino-6-cyclopopylamino-s-triazine, 3-benzo[b]thien-yl-5,6-dihydro-1,4,2-oxathiazine 4-oxide, 4,5-dichloro-2-(n-octyl)-3 (2H)-isothiazolone, 2,4,5,6-tetrachloroisophthalonitrile, tolylfluanid, dichlofluanid, diiodomethyl-p-tosylsulphone, capsaicin and substituted capsaicins, N-cyclopropyl-N′-(1,1-dimethylethyl)-6-(methylthio)-1,3,5-triazine-2, 4-diamine, 3-iodo-2-propynylbutyl carbamate, medetomidine, 1,4-dithiaanthraquinone-2,3-dicarbonitrile (dithianon), boranes such as pyridine triphenylborane, 2-trihalogenomethyl-3-halogeno-4-cyano pyrrole derivatives substituted in position 5 and optionally in position 1, such as 2-(p-chlorophenyl)-3-cyano-4-bromo-5-trifluoromethyl pyrrole (tralopyril), furanones such as 3-butyl-5-(dibromomethylidene)-2 (5H)-furanone, macrocyclic lactones such as avermectins, for example avermectin B1, ivermectin, doramectin, abamectin, amamectin and selamectin, and quaternary ammonium salts such as didecyldimethylammonium chloride and an alkyldimethylbenzylammonium chloride.

The biocide can, in embodiments, be wholly or partially encapsulated, adsorbed, entrapped, supported or bound. Certain biocides are difficult or hazardous to handle and are advantageously used in an encapsulated, entrapped, absorbed, supported, or bound form. Encapsulation, entrapment, absorption, support or binding of the biocide can provide a secondary mechanism for controlling biocide leaching from the coating system in order to achieve an even more gradual release and long-lasting effect. The method of encapsulation, entrapment, adsorption, support or binding of the biocide is not particularly limited. Examples include the use of mono and dual walled amino-formaldehyde or hydrolysed polyvinyl acetate-phenolic resin capsules or microcapsules as described in WO2006/032019. An example of a suitable encapsulated biocide is encapsulated 4,5-dichloro-2-(n-octyl)-3(2H)-isothiazolone marketed by Dow Microbial Control as Sea-Nine CR2 Marine Antifouling Agent. Examples of ways in which an absorbed or supported or bound biocide may be prepared include the use of host-guest complexes such as clathrates as described in EP0709358, phenolic resins as described in EP0880892, carbon-based adsorbents such as those described in EP1142477, or inorganic microporous carriers such as the amorphous silicas, amorphous aluminas, pseudoboehmites or zeolites described in WO00/11949.

### [Pigments, Fillers and Anticorrosive Agents]

In embodiments, one or more pigments, fillers and anticorrosive agents can be included in the coating composition.

Examples of suitable fillers include zinc oxide, barium sulphate, calcium sulphate, calcium carbonate, silicas or silicates (such as talc, feldspar, and china clay), including pyrogenic silica, bentonite and other clays. Some fillers, such as fumed silica, may have a thixotropic effect on the coating composition.

The proportion of fillers may be in the range of from 0 to 25 wt %, based on the total weight of the coating composition. If clay is present, it is in an amount of up to 1 wt %, for example 0.1 to 1 wt %, based on the coating composition as a whole. If a thixotrope is present, it is in an amount of up to 5 wt %, for example from 0.1 to 5 wt %, based on the total weight of the coating composition.

Examples of pigments include black iron oxide, red iron oxide, yellow iron oxide, titanium dioxide, carbon black, graphite, red molybdate, yellow molybdate, zinc sulfide, antimony oxide, sodium aluminium sulfosilicates, quinacridones, phthalocyanine blue, phthalocyanine green, indanthrone blue, cobalt aluminium oxide, carbazoledioxazine, chromium oxide, isoindoline orange, bis-acetoaceto-tolidiole, benzimidazolone, quinaphthalone yellow, isoindoline yellow, tetrachloroisoindolinone, and quinophthalone yellow, and metallic flake materials such as aluminium flakes.

Examples of anticorrosive agents include zinc dust and zinc alloys, and so-called lubricious pigments such as graphite, molybdenum disulfide, tungsten disulphide and boron nitride. If present, they can be in amounts of up to 25 wt % based the coating composition as a whole, for example in the range of from 0.1 to 25 wt %.

In embodiments, where any pigments, fillers or anticorrosive agents are included, they can constitute in total up to 50 wt % of the coating composition based on the total weight of the coating composition, for example up to 40 wt %. In embodiments, there is at least 0.1 wt % of these components, for example at least 5 wt %, at least 10 wt %, or at least 20 wt %. Example ranges include from 0.1 to 50 wt %, from 0.1 to 40 wt %, from 5 to 50 wt %, from 5 to 40 wt %, from 10 to 50 wt %, from 10 to 40 wt %, from 20 to 50 wt % and from 20 to 40 wt %.

### [Properties of the Coating Composition]

The coating composition in embodiments has a non-volatile content of 35 wt % or more, based on the entire weight of the coating composition. In further embodiments, the non-volatile content is 50 wt % or more, for example 70 wt % or more. In embodiments the non-volatile content is 85 wt % or less. Non-volatile content can be determined according to ASTM D2697, e.g. D2697-03 (2014).

In embodiments, the touch dry time of the coating composition at 23° C. and 50% relative humidity is in the range of from 0.1 to 4 hours, for example in the range of from 0.2 to 3 hours. The touch dry time is the time at which slight pressure with a finger reveals no stickiness and leaves no mark in the coating.

In embodiments, the hard dry time is in the range of from 1 to 30 hours at 23° C. and 50% relative humidity, for example from 2 to 20 hours. The hard dry time is the time at which no film disruption and no marks occur when a thumb is pressed firmly on the surface and twisted through 180°.

### [Preparation of the Coating Composition]

The coating composition may be prepared by mechanical mixing of the components, which can be carried out using conventional means and devices, including agitation mixers such as anchor, paddle, propellor, turbine and helical mixers.

In embodiments, the composition is prepared and provided in the separate parts, such as 2-pack or 2-component (2K) systems. However, typically, the coating composition is a 1-pack (1K) composition, i.e. the formulation is provided in a single pack, such that no mixing of separate curing and binder components is necessary at the point of application.

The coating compositions manage to achieve highly effective fouling control performance, without the need for marine biocide.

In embodiments, the coating is a so-called self-polishing coating, i.e. one that is designed to gradually wear-away or erode with time and preventing adherence of fouling organisms, or at least limiting their duration on the coating surface.

### [Application of the Coating Composition]

The coating composition can be applied to a substrate by known methods, for example by conventional air-spraying, or by airless- or airmix-spraying equipment. It can alternatively be applied using brush or roller, for example when used as a stripe coat, or for smaller vessels such as yachts. The composition can be applied at ambient conditions without pre-heating the coating composition. In spraying applications, conventional pressures such as 3 to 6 bara (bar-absolute) can be used.

The coating is typically applied so that a total dry film thickness of from 100-1000 μm is obtained, such as 100-500 μm or 150-350 μm. The applied film thickness can vary depending on the nature of substrate being coated and the environment to which it will be exposed.

### [Coating Systems]

The coating composition can be used on its own or can be part of a coating system comprising more than one coating composition. It can be applied directly to a substrate surface or to a previously coated surface. For example, it can be applied on top of a primer, or an intermediate coat such as a tie-coat.

A particular benefit of the above-described coating compositions is the ability to combine the desirable attributes of good adhesion to undercoats or tie-coats, while still having highly effective fouling control properties.

In embodiments, the coating composition is applied directly to a primed surface. In further embodiments, the coating composition is applied to a tie-coat layer. The tie-coat can be on top of a primer layer, or directly on the substrate surface.

In embodiments, the coating composition is applied directly to a bare substrate. In other embodiments, the coating composition is applied to a previously coated substrate, such that it comprises one or more pre-existing and pre-cured and/or dried coating layers.

In embodiments, the coating composition is applied to a primer layer on the substrate. The origin of the primer layer is not particularly limited, although in embodiments the primer is an epoxy resin-based primer.

In embodiments, the coating composition is applied to a tie-coat layer on the substrate, in which tie-coat layer is optionally on a primer layer on the substrate.

In embodiments, the coating composition forms part of a multi-coat system that additionally comprises a primer and/or a tie-coat.

In embodiments, a tie-coat layer can be applied on top of the primer layer to assist binding of the coating composition with the primer layer. However, in embodiments, no tie-coat is required.

### [Substrate]

The substrate to which the coating is applied can be one that is intended to be immersed, permanently or intermittently, in water when in use. Substrates include metal, concrete, wood or polymeric surfaces.

Polymeric surfaces include polyvinyl chloride (PVC), or composites of fibre-reinforced resins. They also include flexible polymeric carrier foils, e.g. a PVC carrier foil to which the non-coated side is or can be adhered to a different surface.

In embodiments, the substrate is a submergeable surface of a boat or ship, e.g. selected from one or more of the hull(s) (or at least the draft portion of the hull(s)), the propeller(s), and the rudder(s).

### EXAMPLES

The disclosure will now be described with reference to the following, non-limiting examples.

### [Procedure 1—Synthesis of Metallic Ion-Containing Monomer Mixture]

A monomer mixture was prepared following the synthesis scheme from Production Example M3 of EP2489710.

70.1 g xylene, 15.2 g 1-methoxy propan-2-ol and 47.6 g zinc oxide were added to a flask equipped with an overhead stirrer and temperature probe, and heated to 75° C. From a dropping funnel, a mixture of 38.0 g methacrylic acid, 31.6 g acrylic acid, 44.0 g oleic acid, 2.7 g acetic acid and 6.8 g propionic acid was added over a period of 3 hours. The contents were then stirred at 75° C. for a further 2 hours, after which a post-feed charge of 90.0 g xylene and 54.0 g 1-methoxy propanol-2-ol was added, and the mixture allowed to cool. A solid monomer mixture comprising zinc salts of the acids was formed, which was filtered and collected.

### [Procedure 2—Synthesis of an Acrylamide-Modified Polydimethylsiloxane Monomer]

A round bottom flask was equipped with an overhead stirrer, a thermocouple, a condenser and a dropping funnel. It was also attached to a nitrogen line. 200 g monoaminopropyl-terminated PDMS (MCR-A12 from Gelest chemicals), 10.5 g triethylamine (TEA) and 100 ml chloroform were added to the flask, and the temperature reduced to 2° C. using an ice-bath.

The dropping funnel contained 9.4 g acryoyl chloride and 100 ml chloroform, and the contents were slowly added to the round bottom flask over a 5 hour period.

A precipitate of TEA:HCl salt was filtered off, washed with 20 ml chloroform, and the washings were combined with the filtrate. The combined filtrate/washings were washed twice with 200 ml water, one with an aqueous NaCl solution (75 g NaCl in 200 ml water), and once with a saturated sodium bicarbonate solution (16 g NaHCO₃ in 200 ml water).

The organic phase was dried overnight using 30 g sodium sulfate and then filtered to remove the sodium sulfate. The solvent was then removed from the filtrate by rotary evaporation to leave the Acrylamide-modified PDMS.

### [Procedure 3—Synthesis of Metallic Ion-Containing (Meth)Acrylate-Based Copolymer]

A procedure similar to that of Production Example S4 of EP2489710 was used to make two metal-modified anionic polymers, using the materials and quantities listed in Table 1.

Approximately 75 wt % of the total amount of solvent was added to a reaction vessel and heated to 100° C. Separately, the monomer mixture from Procedure 1, additional monomers, and the azo initiators were dissolved in 10 wt % of the total amount of solvent, and added dropwise to the heated reaction vessel under constant stirring over a 5 h period. The remaining 15 wt % of solvent was then used to form a solution with the peroxide initiator, which was then added to the reaction vessel over a 30 minute period. The reaction was continued for a further 90 minutes at 100° C. before being allowed to cool to room temperature.

These experiments were carried out on the copolymer solutions of Example 1 and Comparative Example 1, and also on a comparative commercial fouling control coating Intersleek™ 1100SR (International Paints).

TABLE 1
Anionic copolymer synthesis (amounts in wt %)

| | |
|---|---|
| Example 1 | Comparative Example 1 |

Monomers:

| Metal-containing | 85 | 85 |
|---|---|---|
| monomer mixture ^{[1]} | | |
| PDMS acrylamide ^{[2]} | 100 | |
| Methacryl- | | 100 |
| modified PDMS ^{[3]} | | |
| Methyl methacrylate | 36 | 36 |
| Ethyl acrylate | 30 | 30 |
| Initiators: | | |
| Azobis(isobutyronitrile) | 5 | 5 |
| Azobis(methylbutyronitrile) | 2 | 2 |
| t-butyl peroxy- | 1 | 1 |
| 2-ethylhexanoate | | |
| Solvents: | | |
| Xylene | 113 | 113 |
| 1-methoxypropan-2-ol | 80 | 80 |

^{[1]} from Procedure 1
^{[2]} from Procedure 2
^{[3]} X-22-174BX - a single end methacryl-modified polydimethylsiloxane from Shin-Etsu

### [Antifouling Activity]

Coatings were applied in a 6×6 “latin square” arrangement on plywood test panels. The panels were immersed in sea water in Singapore or the north-east coast of England for a period of 18 weeks, with an interim check being carried out at 9 weeks. The extent of observed fouling was assigned on a scale of 1 to 100, where 100 represents the fouling observed for the performance of the Intersleek™ 1100SR commercial product after 18 weeks, and 0 represents zero observed fouling.

The extent of cracking of the coating was also observed at the end of 18 weeks of immersion. A cracking rating of 1 to 5 was given, where 5 is no cracking observed, and 1 represents severe cracking.

Results are presented in Table 2.

TABLE 2
Fouling control performance

| | Relative coverage | | Cracking |
|---|---|---|---|
| Composition | Week 9 | Week 18 | rating |
| Example 1 | 5 | 2 | 5 |
| Comparative Example 1 | 49 | 71 | 2 |
| Intersleek ™ 1100SR | 72 | 100 | 5 |

Not only does Example 1 show the best activity against fouling, it also has excellent resistance to deterioration matching that of the commercial composition.

### [Flexibility]

Flexibility tests were carried out using a conical mandrel according to ASTM D522. Results are shown in Table 3. High mm values represent poor flexibility, whereas low values represent good flexibility.

Samples were coated onto aluminium panels using a 200 μm drawdown bar and left to dry at ambient temperature for 7 days before testing.

TABLE 3
Flexibility measurements

| Composition | Conical mandrel (mm) |
|---|---|
| Example 1 | 10 |
| Comparative Example 1 | 25 |

The experiment shows that the composition comprising an anionic polymer where the polysiloxane moiety is linked via an amide group is more flexible than a corresponding polymer where the polysiloxane moiety is linked by a different group, in this case a via a carboxyl group.

### [Polishing Rate]

A layer of an epoxy coating (Intergard™ 263 from International Paint) was applied to 23 cm diameter abraded Perspex discs.

Test coatings were applied to the edge of the discs via a 600 μm drawdown cube. The discs were left to dry for 2 weeks at ambient temperature before testing commenced. 5 replica experiments were carried out for each test coating.

The substrates were immersed in sea-water and rotated at 700 rpm. The film thickness was measured at periodic intervals using a laser profilometer, and the film loss calculated. Results are shown in Table 4.

TABLE 4
Polishing rates (loss in film thickness/μm)

| Composi- | Time (Days) | | | | | | | | |
|---|---|---|---|---|---|---|---|---|---|
| tion | 0 | 14 | 29 | 90 | 97 | 133 | 141 | 204 | 218 |
| Compar- | 0 | | 0.75 | 8.42 | | 6.51 | | | 15.49 |
| ative | | | | | | | | | |
| Example 1 | | | | | | | | | |
| Example 1 | 0 | 4.79 | | | 22.31 | | 27.36 | 35.99 | |

The results show a faster rate of polishing for Example 1 compared to the comparative coating, which is often correlated with improved fouling performance. The rate of deterioration is also consistent over the period of the test, indicating that there is no appreciable loss of film integrity, e.g. cracking, that would cause sudden and increasing rates of film loss.

1. A fouling control coating composition comprising an anionic polymer with one or more metallic cations, in which the anionic polymer is an acrylate-based co polymer made from at least one acrylate-based monomer and at least one acrylamide-based monomer having a siloxane moiety covalently bound via an amide group.

2. The fouling control coating composition as claimed in claim 1, in which at least one acrylate-based monomer unit of the anionic polymer comprises an anionic carboxylate ion charge-balanced by one or more metallic cations.

3. The fouling control coating composition as claimed in claim 2, in which the acrylate-based monomer is represented by the following formula: 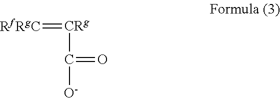
where;
Each R^{f} is selected from H, C₁₋₂₀ aliphatic hydrocarbyl, C₆₋₁₂ aryl, C₆₋₁₂ aryl with one or more C₁₋₆ alkyl, C(O)O, and C(O)OR^{t};
Each R⁸ is independently selected from H and C₁₋₂₀ aliphatic hydrocarbyl (e.g. alkyl), C₆₋₁₂ aryl, and C₆₋₁₂ aryl substituted with one or more (e.g. 1 to 4) C₁₋₆ aliphatic hydrocarbyl groups;
Each R^{t} is independently selected from H, C₁₋₆ alkyl, and C₁₋₆ haloalkyl;
The optional substituents on R^{a}, R^{b} and R^{c} are selected from halide, —OR^{t}, and —N(R^{t})₂;
The optional substituents for R^{g} are selected from halide, —OR^{t}, —N(R^{t})₂, —Si(R^{b})_{3-d}(OR^{a})_{d}, —OC(O)R^{t}, —C(O)N(R^{t})₂, and —OC(O)N(R^{t})₂, —([CR¹₂]ⱼE-)ₚR^{t}, and -E-([CR^{t}₂]ⱼE-)ₚR^{t};
The optional substituents for R^{f} are selected from halide, —OR^{t}, —N(R^{t})₂, —Si(R^{b})_{3-d}(OR^{a})_{d}, —C(O)O⁻, —C(O)OR^{t}—OC(O)R^{t}, —C(O)N(R^{t})₂, and —OC(O)N(R^{t})₂, —([CR^{t}₂]ⱼE-)ₚR^{t}, and -E-([CR^{t}₂]ⱼE-)ₚR^{t};
Each R^{a} is independently selected from H, C₁₋₁₂ alkyl, phenyl, and phenyl substituted with 1 or more (e.g. 1 to 4) C₁₋₆ alkyl groups;
Each R^{b} is independently selected from H and R^{c};
Each R^{c} is independently selected from optionally substituted C₁₋₂₀ aliphatic hydrocarbyl groups, optionally substituted C₆₋₁₂ aryl groups, and optionally substituted C₆₋₁₂ aryl groups having one or more C₁₋₆ alkyl groups;
Each E is independently selected from O and NR^{t};
Each d is independently in the range of from 0 to 3;
Each j is independently in the range of from 1 to 6; and
Each p is independently in the range of from 1 to 20.

4. The fouling control composition as claimed in claim 3, wherein the acrylate-based monomer has one or more of the following features:
(i) Each R^{g} is selected from H and unsubstituted C₁₋₆ alkyl;
(ii) R^{f} is selected from H and C₁₋₆ alkyl optionally substituted with one substituent selected from —C(O)O⁻ and C(O)OR^{t};

5. The fouling control composition as claimed in claim 1, wherein the acrylamide-based monomer having a siloxane moiety covalently bound via an amide groups is represented by the following formula: 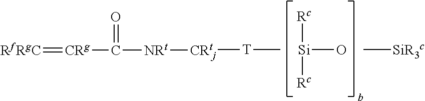
wherein;
Each R^{a} is independently selected from H, C₁₋₁₂ alkyl, phenyl, and phenyl substituted with 1 or more (e.g. 1 to 4) C₁₋₆ alkyl groups;
Each R^{b} is independently selected from H and R^{c};
Each R^{c} is independently selected from optionally substituted C₁₋₂₀ aliphatic hydrocarbyl groups, optionally substituted C₆₋₁₂ aryl groups, and optionally substituted C₆₋₁₂ aryl groups having one or more C₁₋₆ alkyl groups;
Each R^{f} is selected from H, C₁₋₂₀ aliphatic hydrocarbyl, C₆₋₁₂ aryl, C₆₋₁₂ aryl with one or more C₁₋₆ alkyl, C(O)O⁻, and C(O)OR^{t};
Each R^{g} is independently selected from H and C₁₋₂₀ aliphatic hydrocarbyl (e.g. alkyl), C₆₋₁₂ aryl, and C₆₋₁₂ aryl substituted with one or more (e.g. 1 to 4) C₁₋₆ aliphatic hydrocarbyl groups;
Each R^{t} is independently selected from H, C₁₋₆ alkyl, and C₁₋₆ haloalkyl;
The optional substituents on R^{a}, R^{b} and R^{c} are selected from halide, —OR^{t}, and —N(R^{t})₂;
The optional substituents for R^{g} are selected from halide, —OR^{t}, —N(R^{t})₂, —Si(R^{b})_{3-d}(OR^{a})_{d}, —OC(O)R^{t}, —C(O)N(R^{t})₂, and —OC(O)N(R^{t})₂, —([CR^{t}₂]ⱼE-)ₚR^{t}, and -E-([CR^{t}₂]ⱼE-)ₚR^{t};
The optional substituents for R^{f} are selected from halide, —OR^{t}, —N(R^{t})₂, —Si(R^{b})_{3-d}(OR^{a})_{d}, —C(O)O⁻, —C(O)OR^{t}—OC(O)R^{t}, —C(O)N(R^{t})₂, and —OC(O)N(R^{t})₂, —([CR^{t}₂]ⱼE-)ₚR^{t}, and -E-([CR^{t}₂]ⱼE-)ₚR^{t};
Each E is independently selected from O and NR^{t};
T is —O—, —NR^{t}—, or is absent;
b is in the range of from 4 to 150;
Each d is independently in the range of from 0 to 3;
Each j is independently in the range of from 1 to 6; and
Each p is independently in the range of from 1 to 20.

6. The fouling control composition as claimed in claim 5, in which one or more of the following apply:
(i) Each R^{g} and R^{f} are independently selected from H and unsubstituted C₁₋₆ alkyl;
(ii) Each of R^{a}, R^{b} and L are independently selected from unsubstituted C₁₋₆ alkyl and phenyl optionally substituted with one or more C₁₋₆ unsubstituted alkyl groups;
(iii) Each R^{t} is independently selected from H and C₁₋₆ alkyl;
(iv) there are no halide groups in the monomer;
(v) T is absent;
(vi) j is in the range of from 2 to 4.

7. The fouling control composition as claimed in claim 1, in which the siloxane substituent is a polydimethylsiloxane substituent.

8. The fouling control composition as claimed in claim 1, in which the siloxane-modified anionic polymer is a thermoplastic polymer.

9. The fouling control coating composition as claimed in claim 1, in which the metal cations are selected from Mg, Ca, Zn and Cu.

10. The fouling control coating composition as claimed in claim 1, which is a self-polishing fouling control coating composition.

11. A method for controlling aquatic biofouling on a man-made object, comprising applying the fouling control coating composition as claimed in claim 1 onto the surface of a man-made structure, the man-made structure being a structure that is intended to be permanently or intermittently immersed in water.

12. A substrate or article coated with the fouling control coating composition as claimed in claim 1.

13. (canceled)

14. (canceled)
